(19) United States
(12) Patent Application Publication
(10) Pub. No.: US 2025/0044862 A1
(43) Pub. Date: Feb. 6, 2025

(54) BREAK TYPE RECOMMENDATION USING MACHINE LEARNING

(71) Applicant: INTERNATIONAL BUSINESS MACHINES CORPORATION, ARMONK, NY (US)

(72) Inventors: Martin G. Keen, Cary, NC (US); Jeremy R. Fox, Georgetown, TX (US); Bahman Hekmatshoartabari, White Plains, NY (US); Alexander Reznicek, Troy, NY (US)

(21) Appl. No.: 18/362,060

(22) Filed: Jul. 31, 2023

(51) Int. Cl. G06F 3/01

(52) U.S. Cl. CPC G06F 3/013

(57) ABSTRACT

A computer-implemented method, a computer system and a computer program product recommend an optimal break for a user. The method includes capturing activity data for the user from an environment using a device. The method also includes obtaining prior activity data related to the user and identifying a preferred break type for the user, wherein the preferred break type for the user is associated with a prior activity of the user. In addition, the method includes determining that the user needs a break from a current activity based on the activity data. The method further includes generating a break recommendation for the user, wherein the break recommendation associates the preferred break type for the user with the current activity in the activity data. Lastly, the method includes displaying the break recommendation to the user.

### BACKGROUND

Embodiments relate generally to the field of computer software and machine learning and, more specifically, to using information about user activity in a machine learning model to recommend a type of break to users.

In the current environment, it may be common for people to seek optimal efficiency in their everyday tasks, e.g., work, learning/education, personal improvement, as well as maximum productivity. It may therefore be common for many people to work harder at maximum levels, which may lead to burnout and poor work product. To avoid burnout and other negative effects, a person may take a break or distraction, which, in many fields, may benefit overall productivity and also improve the health and well-being of the person. The effects of taking a break may be greatly influenced by taking a break at the proper type and also taking the type of break, such as the length of time needed to be away from the main activity or a potential alternative activity that may be preferred by the person, that may be optimal for the person in a specific situation.

### SUMMARY

An embodiment is directed to a computer-implemented method for recommending an optimal break for a user. The method may include capturing activity data for the user from an environment using a device. The method may also include obtaining prior activity data related to the user and identifying a preferred break type for the user, where the preferred break type for the user is associated with a prior activity of the user. The method may further include determining that the user needs a break from a current activity based on the activity data. In addition, the method may include generating a break recommendation for the user, where the break recommendation associates the preferred break type for the user with the current activity in the activity data. Lastly, the method may include displaying the break recommendation to the user.

In another embodiment, the method may include monitoring user interactions with the break recommendation and updating the break recommendation based on the user interactions.

In a further embodiment, the displaying the break recommendation to the user may include adding visual cues relating to the break recommendation to a display in an augmented reality (AR) device associated with the user.

In yet another embodiment, the device may comprise an eye tracking device and the determining that the user needs a break from the current activity may include identifying an eye movement of the user performing a current activity in the activity data.

In still another embodiment, the identifying the preferred break type for the user may utilize a machine learning model that predicts a type of break from ongoing tasks based on user activity.

In an additional embodiment, the generating the break recommendation for the user may utilize a machine learning model that applies the preferred break type for the user to an identified activity in the activity data.

In another embodiment, the method may include determining that a group of users includes the user and transmitting the break recommendation to one or more devices associated with the group of users.

In addition to a computer-implemented method, additional embodiments are directed to a computer system and a computer program product for recommending an optimal break for a user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts a flow chart diagram for a process that recommends an optimal break for a user according to an embodiment.

### DETAILED DESCRIPTION

In today's fast-paced world, where individuals, or users, may be faced with many tasks and activities that require a high level of concentration, such as working with mobile technological devices, in a short period of time, it may be critical for those individuals to take breaks from such tasks or activities to maintain productivity and efficiency and also to remain healthy. However, it may also be common for these individuals to forget to take regular breaks or to be unaware of an optimal time to take a break. In addition to timing, the type of break may also be important to specific individuals to get the most positive effect from the break. For instance, if a user has been working in front of a screen for a long period of time, the best break type may be to refocus the eyes on something else for a short period of time. However, in other situations, a user may find it more helpful to engage in physical exercise or stretching or spending time with family or friends. As a result, it may be important to understand both the immediate state of a user in the current activity and also the prior activity history of a user to know the most effective break.

It may therefore be useful to provide a method or system to provide intelligent break reminders and recommend an optimal break for a user. Such a method or system may leverage Artificial Intelligence (AI) and eye tracking technology to provide users with an intelligent break reminder solution. For example, the system or method may analyze a user's gaze and eye movements for the purpose of determining that the user needs a break from a current activity and may provide customized advice and recommendations on break type, which may include when to take the break, a length of time for the break and the type of break that the user should take, with the goal of improving user productivity and efficiency, in addition to user well-being and health. Augmented Reality (AR) and Internet of Things (IoT) technology may also be optionally used to provide the user with visual cues on a computer screen or other device, such as a smart phone or other connected device. Such a method or system may enhance existing software applications used in the marketplace, including but not limited to voice assistant applications such as Google Assistant or Amazon Alexa, to improve efficiency and health through more relevant and detailed reminders to human users.

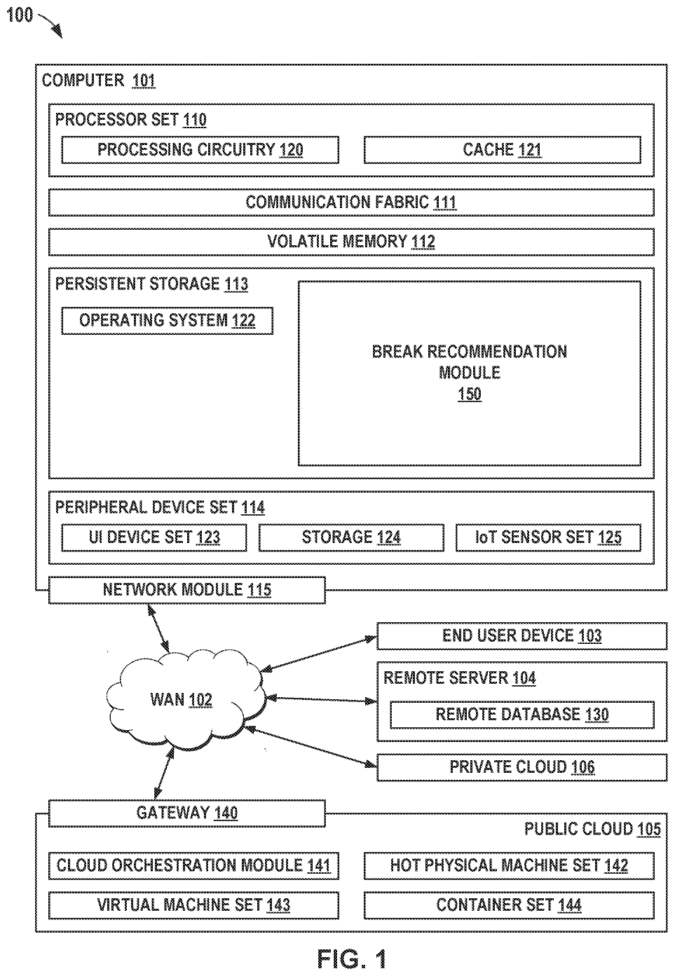

Referring to FIG. 1, computing environment 100 contains an example of an environment for the execution of at least some of the computer code involved in performing the inventive methods, such as break recommendation module 150. In addition to break recommendation module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and break recommendation module 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in break recommendation module 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in model splitting break recommendation module 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Computer environment 100 may be used to recommend an optimal break for a user using machine learning. In particular, break recommendation module 150 may capture activity data from an environment, such as a home or office, or any area where a user may be performing an activity. The activity data may be manifested in several alternative forms, e.g., images or video, audio only, or text conversations. In addition, the module 150 may obtain prior activity data for the user and identify a preferred break type for the user that may be associated with specific prior activities in the data. Information about prior activities may be resident in the module 150 or may be alternatively retrieved from a server, a database or other indexed storage. Identification of the preferred break type associated with specific activities may use a machine learning model trained to predict the preferred break type based on the prior activity data. The break recommendation module 150 may determine that the user needs a break from the current activity, for example using computer vision techniques such as, but not limited to, eye movement or gaze detection and may generate a break recommendation. The break recommendation generated by the module 150 may include any or all of multiple characteristics, including as an example the length of break time that may be necessary and also the type of break that may be desired or needed, which may be informed by the preferred break type for the user that has been identified. Once this break recommendation has been generated, the break recommendation may be displayed to the user on an appropriate device, e.g., a mobile device display or a fixed monitor in a common area, or the user may be notified through a message or other method.

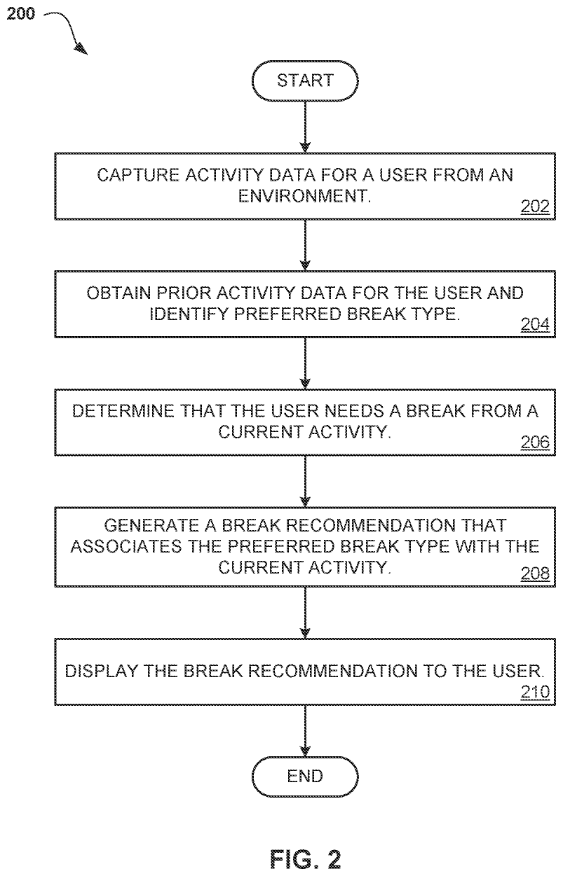

Referring to FIG. 2, an operational flowchart illustrating a process 200 that recommends an optimal break for a user. At 202, activity data for a user may be captured from an environment using an appropriate device. The activity data may include images or video captured with a camera, audio captured with a microphone, text conversations using appropriate software or data from Internet of Things (IoT) devices that may be used to perform the activity, though it should be noted that this is not an exhaustive list of possible types of activity data. As an example, a camera, fixed or non-fixed such as in a mobile device, may be placed nearby to capture users performing activities such as working on a computer screen or physically demanding tasks such as exercise or lifting heavy items in a warehouse environment. It is important to note that this is a non-exhaustive list of the sources of activity data and the devices that may be used to capture the activity data.

In an embodiment, the camera may be in a “continuous record” mode, such that no trigger is required to begin capture and/or recording. In such a scenario, the camera may also, at the option of a user or administrator of the environment, be switched out of the “continuous record” mode, e.g., have the mode shut off. The same method of recording may be used with a microphone to capture audio in the environment. In addition to video or audio, devices within the environment may be set to transmit data, e.g., biometric information about an individual within the environment or text messages that may be sent to or from at least one individual in the environment. It is not necessary for there to be many devices under control but rather that there be a mechanism for accepting voice or video input, or text and other data, from the environment that includes users performing tasks or activities. For instance, microphones or cameras or other devices may be mounted within the environment in conspicuous or inconspicuous locations, such as within a collaborative space such as a conference room in an office or perhaps a cafeteria in an office building. One alternative to fixed devices in a location may be devices embedded in a smartphone or other mobile device that may be carried by an individual within the common area environment, which may include a microphone or camera or even biometric data if the owner of the smartphone has a sensor attached and a corresponding application running on the smartphone. One of ordinary skill in the art would appreciate that one or more devices may be arranged in multiple ways to capture users and activities or tasks that may be occurring within the environment.

It also should be noted that monitoring user activities, e.g., using a camera in a “continuous record” mode, as used herein requires the informed consent of all people whose activities are captured for analysis. Consent may be obtained in real time or through a prior waiver or other process that informs a subject that their likeness will be captured by a camera and/or voice will be captured by a microphone and that the video and/or audio will be analyzed by a machine learning model to predict and recommend an appropriate break from activities or tasks. In addition, any audio and/or video or other data that may be captured by the module 150 may be stored, subject to the user consent restrictions described above and also contingent on whether the data may include sensitive information, to allow for a processing buffer in the analysis of the data and predicting or recommending an appropriate break for the user. Sensitive information may be filtered from capture or storage and therefore prevented from being retained or sent to a remote server. Information classified as not sensitive may be forwarded for further processing by the module 150.

The decisions for filtering content may be set by an owner of sensitive information or with training data that may be put into a classification model. The filter, or the ability to mark information as sensitive or not sensitive with respect to the machine learning classifier, may be configured for the information to be transmitted to the cloud server or may be configured for each piece of information. In an initial state, transmission of all pieces of information may be disabled and only logging of information may be performed, such that no information may be sent to any remote server. This default initial setting means the owner of the potentially sensitive information is required to consent to any information being retained or transmitted over a network.

At 204, prior activity data related to the user may be obtained from a server or any local or remote location and a preferred break type for the user may be identified by the module 150 that is associated with a prior activity. The prior activity data may take the same or similar forms as the activity data in the previous step, i.e., images or video or text, and may represent prior activities that the user may have performed. For instance, the user may normally sit at a computer screen for long periods of time and take breaks by walking a short distance and refocusing eyes or stretching at a nearby window. The length of time between first sitting down and any subsequent breaks may be noted in the prior activity data, as well as the time taken in a break and the type of break that the user has taken. A pattern may be detected in the obtained data from one or many prior activities and a preferred break type may be developed for the user that is associated with the prior activity. As an example, the user above who normally may sit at a screen may also take a break after 30 minutes at the screen and usually stand up and stretch and look out in the distance to refocus the eyes for 5-10 minutes before continuing at the computer screen. Over the course of monitoring this activity, the user's preferences may be determined. A non-exhaustive list of examples of the preferred break types may include a short walk to refocus eyes, stretching near a window, breathing exercises with closed eyes, meditation with deep breathing, running, organized physical activities, and time with family and friends.

In an embodiment, a supervised machine learning model may be trained to predict a preferred break type based on the prior activity data. One or more of the following machine learning algorithms may be used: logistic regression, naive Bayes, support vector machines, deep neural networks, random forest, decision tree, gradient-boosted tree, multilayer perceptron. In an embodiment, an ensemble machine learning technique may be employed that uses multiple machine learning algorithms together to assure better classification when compared with the classification of a single machine learning algorithm. In this embodiment, training data for the model may include the prior activity data described above or any information that may be obtained about the user, such as manually entered responses to questions that explicitly state a user's preferences. The training data may be collected from a single prior activity or from multiple prior activities obtained over a longer period of time. The results may be stored in a database so that the data is most current, and the output would always be up to date.

At 206, it may be determined from the activity data that the user needs a break from an activity that is currently being performed. In an embodiment, a machine learning model may be designed and coded using deep learning techniques such as conventional neural networks (CNNs) or Long Short-Term Memory (LSTM) networks to analyze eye movements or gaze information about the user for determining that the user needs a break from the current activity. To accomplish this, an eye tracking device may be used as the capture device for the activity data and eye movements of the user may be monitored, including gaze estimation methods such as Pupil-Centered Model or Appearance-Based Model or other computer vision techniques and natural language processing (NLP) algorithms. It is important to note that detection of eye movements and gaze detection as described herein does not specifically identify the user to the module 150, but rather determines a state of the user and the need for a break from the current activity, under the consent provisions described above for use of the module 150 and personally identifying information. Potential eye tracking devices may include any high-accuracy and low-latency device that may connect to the module 150, along with the appropriate software to communicate with the chosen device. It should be noted that gaze detection need not be the exclusive method of determining when the user needs a break as one of ordinary skill in the art will recognize that there are many alternative methods for detecting the current state of a user and predicting that a break from a current activity may be needed.

At 208, a break recommendation may be generated for the user that associates the preferred break type with the activity that is currently being performed. Such a break recommendation may be the aggregation of the previous steps, where the user may be determined to need a break from an identified current activity and an understanding of user preferences for such a break may now be known.

In an embodiment, a supervised machine learning model may be trained to apply the preferred break type for the user to an identified current activity in the activity data. One or more of the following machine learning algorithms may be used: logistic regression, naive Bayes, support vector machines, deep neural networks, random forest, decision tree, gradient-boosted tree, multilayer perceptron. One of ordinary skill in the art will recognize that this is a non-limiting list of algorithms that may be used at this step. In an embodiment, an ensemble machine learning technique may be employed that uses multiple machine learning algorithms together to assure better classification when compared with the classification of a single machine learning algorithm. The results may be stored in a database so that the data is most current, and the output would always be up to date.

At 210, the break recommendation may be displayed to the user. This display may take the form of a visual display on a computer screen, either fixed in the environment such that the user may view the recommendation or may be an alert on one or more mobile devices associated with the user, such as smartphones, smartwatches, or smart speakers. The break recommendation may also take the form of an audio-only, vibration alert or text notification that may be transmitted to the user, such that the user may take action based on the break recommendation.

In an embodiment, the display or notification may take the form of visual cues that may be added to an augmented reality (AR) display that may be viewed with an appropriate device that may be worn or otherwise operated by the user. The visual cues may be textual or graphic alerts of the need for a break and may also include text about the break type that may be recommended for the user, including a possible path for a recommended walk or contact information for recommended organized physical activities that may be nearby or previously used. To accomplish the display of visual cues in augmented reality, any appropriate library may be installed and used. One of ordinary skill in the art may recognize that the display of a break recommendation may take any of several forms and include relevant information to the user and the break recommendation.

In an embodiment, the break recommendation module 150 may further determine that the user may be part of a team, such as a worker in a factory or hospital. The module 150 may know which devices are associated with the team or individual team members and transmit the break recommendation to any or all devices associated with the team, such that another member of the team may relieve the user that needs a break. Management in such a work scenario may also be informed of the break recommendation to keep track of current activities and team members, as well as properly logging any time or other information that may be relevant to the team member, the workplace or the break recommendation.

Included at this step may be a feedback mechanism, whereby the interaction of a user with the generated break recommendation may be monitored and used to refine the machine learning model for predicting the preferred break type for the user or the determination of when the user needs a break from the current activity. Once a break recommendation is displayed, the user may indicate whether or not a break may be needed and also whether or not the preferred break type associated with the current activity is correct. In addition, the movements of the user may be monitored using available motion sensors or mobile device GPS data to determine the actual break that may be taken by the user in response to the break recommendation. At the same time, the eye movements of the user may also be monitored for the purpose of determining the effectiveness of the break that may be taken. This information may also be used to update the machine learning models that may predict a preferred break type and determine the necessity of a break. Using any or all of the feedback, the module 150 may adjust its learning such that the module 150 may remain adaptive and responsive to the user's changing needs and preferences.

It is important to note again that, at all times, any information that may be obtained by the break recommendation module 150 that may include information sensitive to the user, such as current whereabouts or other personally identifying data, requires the explicit consent of the user, which may be obtained in the methods described above. All uses of the data must be disclosed to the user prior to any information being obtained by the module 150 and the user has the right to revoke consent for the use of data for any or all of the foregoing data analysis at any time.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for recommending an optimal break for a user, the computer-implemented method comprising:
capturing activity data for the user from an environment using a capture device;
obtaining prior activity data related to the user and identifying a preferred break type for the user, wherein the preferred break type for the user is associated with a prior activity of the user;
determining that the user needs a break from a current activity based on the activity data;
generating a break recommendation for the user, wherein the break recommendation associates the preferred break type for the user with the current activity in the activity data; and
displaying the break recommendation to the user.

2. The computer-implemented method of claim 1, further comprising:
monitoring user interactions with the break recommendation; and
updating the break recommendation based on the user interactions.

3. The computer-implemented method of claim 1, wherein the displaying the break recommendation to the user further comprises adding visual cues relating to the break recommendation to a display in an augmented reality (AR) device associated with the user.

4. The computer-implemented method of claim 1, wherein the capture device comprises an eye tracking device and the determining that the user needs the break from the current activity comprises identifying an eye movement of the user while performing the current activity in the activity data.

5. The computer-implemented method of claim 1, wherein the identifying the preferred break type for the user utilizes a machine learning model that predicts a type of break from ongoing tasks based on user activity.

6. The computer-implemented method of claim 1, wherein the generating the break recommendation for the user utilizes a machine learning model that applies the preferred break type for the user to an identified activity in the activity data.

7. The computer-implemented method of claim 1, further comprising:
determining that a group of users includes the user; and
transmitting the break recommendation to one or more devices associated with the group of users.

8. A computer system for recommending an optimal break for a user, the computer system comprising:
one or more processors, one or more computer-readable memories, and one or more computer-readable storage media;
program instructions, stored on at least one of the one or more computer-readable storage media for execution by at least one of the one or more processors via at least one of the one or more computer-readable memories, to capture activity data for the user from an environment using a device;
program instructions, stored on at least one of the one or more computer-readable storage media for execution by at least one of the one or more processors via at least one of the one or more computer-readable memories, to obtain prior activity data related to the user and identify a preferred break type for the user, wherein the preferred break type for the user is associated with a prior activity of the user;
program instructions, stored on at least one of the one or more computer-readable storage media for execution by at least one of the one or more processors via at least one of the one or more computer-readable memories, to determine that the user needs a break from a current activity based on the activity data;
program instructions, stored on at least one of the one or more computer-readable storage media for execution by at least one of the one or more processors via at least one of the one or more computer-readable memories, to generate a break recommendation for the user, wherein the break recommendation associates the preferred break type for the user with the current activity in the activity data; and
program instructions, stored on at least one of the one or more computer-readable storage media for execution by at least one of the one or more processors via at least one of the one or more computer-readable memories, to display the break recommendation to the user.

9. The computer system of claim 8, further comprising:
program instructions, stored on at least one of the one or more computer-readable storage media for execution by at least one of the one or more processors via at least one of the one or more computer-readable memories, to monitor user interactions with the break recommendation; and
program instructions, stored on at least one of the one or more computer-readable storage media for execution by at least one of the one or more processors via at least one of the one or more computer-readable memories, to update the break recommendation based on the user interactions.

10. The computer system of claim 8, wherein the program instructions, stored on at least one of the one or more computer-readable storage media for execution by at least one of the one or more processors via at least one of the one or more computer-readable memories, to display the break recommendation to the user further comprise program instructions, stored on at least one of the one or more computer-readable storage media for execution by at least one of the one or more processors via at least one of the one or more computer-readable memories, to add visual cues relating to the break recommendation to a display in an augmented reality (AR) device associated with the user.

11. The computer system of claim 8, wherein the device comprises an eye tracking device and the program instructions, stored on at least one of the one or more computer-readable storage media for execution by at least one of the one or more processors via at least one of the one or more computer-readable memories, to determine that the user needs the break from the current activity comprise program instructions, stored on at least one of the one or more computer-readable storage media for execution by at least one of the one or more processors via at least one of the one or more computer-readable memories, to identify an eye movement of the user while performing the current activity in the activity data.

12. The computer system of claim 8, wherein the program instructions, stored on at least one of the one or more computer-readable storage media for execution by at least one of the one or more processors via at least one of the one or more computer-readable memories, to identify the preferred break type for the user utilize a machine learning model that predicts a type of break from ongoing tasks based on user activity.

13. The computer system of claim 8, wherein the program instructions, stored on at least one of the one or more computer-readable storage media for execution by at least one of the one or more processors via at least one of the one or more computer-readable memories, to generate the break recommendation for the user utilize a machine learning model that applies the preferred break type for the user to an identified activity in the activity data.

14. The computer system of claim 8, further comprising:
program instructions, stored on at least one of the one or more computer-readable storage media for execution by at least one of the one or more processors via at least one of the one or more computer-readable memories, to determine that a group of users includes the user; and
program instructions, stored on at least one of the one or more computer-readable storage media for execution by at least one of the one or more processors via at least one of the one or more computer-readable memories, to transmit the break recommendation to one or more devices associated with the group of users.

15. A computer program product for recommending an optimal break for a user, the computer program product comprising:
one or more computer-readable storage media;
program instructions, stored on at least one of the one or more computer-readable storage media, to capture activity data for the user from an environment using a device;
program instructions, stored on at least one of the one or more computer-readable storage media, to obtain prior activity data related to the user and identify a preferred break type for the user, wherein the preferred break type for the user is associated with a prior activity of the user;
program instructions, stored on at least one of the one or more computer-readable storage media, to determine that the user needs a break from a current activity based on the activity data;
program instructions, stored on at least one of the one or more computer-readable storage media, to generate a break recommendation for the user, wherein the break recommendation associates the preferred break type for the user with the current activity in the activity data; and
program instructions, stored on at least one of the one or more computer-readable storage media, to display the break recommendation to the user.

16. The computer program product of claim 15, further comprising:
program instructions, stored on at least one of the one or more computer-readable storage media, to monitor user interactions with the break recommendation; and
program instructions, stored on at least one of the one or more computer-readable storage media, to update the break recommendation based on the user interactions.

17. The computer program product of claim 15, wherein the program instructions, stored on at least one of the one or more computer-readable storage media, to display the break recommendation to the user further comprise program instructions, stored on at least one of the one or more computer-readable storage media, to add visual cues relating to the break recommendation to a display in an augmented reality (AR) device associated with the user.

18. The computer program product of claim 15, wherein the device comprises an eye tracking device and the program instructions, stored on at least one of the one or more computer-readable storage media, to determine that the user needs the break from the current activity comprise program instructions, stored on at least one of the one or more computer-readable storage media, to identify an eye movement of the user while performing the current activity in the activity data.

19. The computer program product of claim 15, wherein the program instructions, stored on at least one of the one or more computer-readable storage media, to identify the preferred break type for the user utilize a machine learning model that predicts a type of break from ongoing tasks based on user activity.

20. The computer program product of claim 15, wherein the program instructions, stored on at least one of the one or more computer-readable storage media, to generate the break recommendation for the user utilize a machine learning model that applies the preferred break type for the user to an identified activity in the activity data.
